(19) United States
(12) Patent Application Publication
(10) Pub. No.: US 2017/0137696 A1
(43) Pub. Date: May 18, 2017

(54) METHOD TO INCREASE GRAVITY DRAINAGE RATE IN OIL-WET/MIXED-WET FRACTURED RESERVOIR

(71) Applicant: BOARD OF REGENTS, THE UNIVERSITY OF TEXAS SYSTEM, Austin, TX (US)

(72) Inventor: Kishore K. Mohanty, Austin, TX (US)

(21) Appl. No.: 15/319,998

(22) PCT Filed: Jun. 11, 2015
(86) PCT No.: PCT/US15/35246

§ 371 Date: Dec. 19, 2016

Related U.S. Application Data
(60) Provisional application No. 62/013,568, filed on Jun. 18, 2014.

(51) Int. Cl. C09K 8/584; E21B 43/16; E21B 49/00; C09K 8/588

(52) U.S. Cl. CPC C09K 8/584; C09K 8/588; E21B 43/16; E21B 49/00

(57) ABSTRACT

The present invention provides a method for treating a fractured oil-wet/mixed-wet subterranean formation with a wettability altering agent by forming a fluid comprising a wettability altering agent; introducing the fluid into the fractures of a subterranean formation; and modifying the wettability of the formation near the fracture surface, wherein the wettability modification results in oil flowing within a fracture instead of reimbibing.

### TECHNICAL FIELD OF THE INVENTION

The present invention relates in general to the field of oil recovery, and more particularly, to a process for altering wettability using altering fluids through a subterranean oil-bearing formation to enhance oil recovery therefrom.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with oil recovery. Stimulation of subterranean hydrocarbon reservoirs and injector wells are widely carried out in the oilfield services industry and include matrix acidizing, hydraulic fracturing, acid-fracturing, sand control, enhanced oil-recovery, etc. use aqueous fluids to impact hydrocarbon productivity. However, the majority of the aqueous fluids are executed with little knowledge of or consideration for the wettability (water-wet or oil-wet) or the partial water/oil saturation of the rock being treated.

A variety of supplemental recovery techniques have been employed in order to increase the recovery of oil from subterranean reservoirs. The most widely used supplemental recovery technique is fluid flooding which involves the injection of a fluid, such as water or a miscible solvent into an oil-bearing reservoir. As the fluid moves through the reservoir, it acts to displace oil therein to a production system of wells through to recover oil.

Many oil-wet/mixed-wet fractured reservoirs employ gravity drainage to recover oil. The gravity drainage is caused by the density difference between the injected fluid (e.g., gas, steam, water, surfactant-water), and oil. The gravity drainage is often controlled by the thickness of the pay zone, even though vertical barriers are present in the matrix which is broken up into several layers. The oil drains out of the top layers into the vertical fractures, but reimbibes into the underneath layer because the matrix is oil-wet/mixed-wet. Thus, the drainage rate is inversely proportional to the total height of the whole pay zone and therefore it is slow.

U.S. Pat. No. 4,842,065, entitled “Oil recovery process employing cyclic wettability alteration,” discloses a surfactant solution injected into an oil-wet fractured formation and becomes the preferred wetting phase of the matrix blocks in the formation thereby displacing oil from the matrix blocks into the fracture network. The formation is then flooded with water to displace the oil from the fracture network to the surface while returning the matrix blocks to an oil-wet condition. The injection cycle is repeated until the formation is depleted.

U.S. Pat. No. 5,042,580, entitled “Oil recovery process for use in fractured reservoirs,” discloses a process for recovering oil from fractured formations which involves altering the wettability of the formation, particularly at the interface of the fracture and rock matrix. The process improves the ability of injected fluids flowing in the fracture to enter the rock matrix to displace oil.

U.S. Pat. No. 7,921,911, entitled “Surface-modifying agents for wettability modification,” discloses a method and composition for treating a subterranean formation with a fluid including a particulate and an organosilane with the chemical formula RₙSiX₄₋ₙ, wherein n is equal to 1, 2, or 3, R is an organic functional group, and X is a halogen, alkoxy, or acetoxy group, introducing the fluid into a subterranean formation with exposed surfaces, and modifying the wettability of a surface of the particulate or subterranean formation or both. A method and composition for treating a subterranean formation with a fluid including a particulate and an organosilane, introducing the fluid into a subterranean formation with exposed surfaces, and modifying the wettability of the proppant or surfaces or both, wherein the wettability modification degrades. The entire contents of which are incorporated herein by reference.

### SUMMARY OF THE INVENTION

Current gravity drainage technology in oil-wet/mixed-wet fractured rocks allows reimbibition of oil into underneath layers since the rock imbibes oil. The present invention provides methods and compositions to make the rock more water-wet so that oil reimbibition can be prevented to increase the oil drainage rate during gravity drainage.

In a gravity-drainage process, a small amount of a rate enhancer is injected into the fractures in terms of an aqueous solution or foam before or during gas or steam injection from the top (or water/surfactant-water injection from the bottom). The treatment can be repeated periodically if the effect of the chemical degrades over the long drainage time.

The present invention provides a process for enhancing oil recovery from an oil-wet/mixed-wet fractured oil-bearing formation by identifying a fractured reservoir comprising a multilayered matrix, in communication with a fracture at a matrix-fracture interface; providing an injection fluid comprising a wettability altering agent; injecting the injection fluid into the fractured reservoir; contacting the matrix at the matrix-fracture interface with the wettability altering agent; and altering the wettability of the matrix-fracture interface to a more hydrophilic state, wherein oil produced from the upper matrix flows within the fracture instead of reimbibing into the lower matrix underneath. The injection fluid may be any injection fluid with a wettability altering agent or a foam of this injection fluid and a gas. The injection fluid may be injected into the fractured reservoir at a reservoir top, a reservoir bottom or both and the injection may be before or during the gravity drainage process into the fracture. The wettability altering agents include cationic surfactants, anionic surfactants, nonionic surfactants, aqueous ions, chelating agents, sequestration agents, acids, alkali, solvents, silanes, fatty acid complexes, and aromatic/asphaltic oils. For example, the wettability altering agent is sodium polyacrylate (NaPA), ENORDET® A092 or both.

The present invention provides a method for treating a subterranean formation with a wettability altering agent by forming a fluid comprising a wettability altering agent; introducing the fluid into a subterranean formation with exposed surfaces; and modifying the wettability of the particulate or surfaces or both, wherein the wettability modification results in oil flowing within a fracture instead of reimbibing. The injection fluid may be any injection fluid with a wettability altering agent or a foam of this injection fluid and a gas. The injection fluid may be injected into the subterranean formation at a reservoir top, a reservoir bottom or both and the injection may be before or during the gravity drainage process into the subterranean formation. The wettability altering agent include cationic surfactants, anionic surfactants, nonionic surfactants, aqueous ions, chelating agents, sequestration agents, acids, alkali, solvents, silanes, fatty acid complexes, and aromatic/asphaltic oils. For example, the wettability altering agent is sodium polyacrylate (NaPA), ENORDET® A092 or both.

The present invention provides a process for increasing a gravity drainage rate for oil recovery in oil-wet/mixed-wet fractured oil-bearing formation by identifying a fractured reservoir comprising an upper matrix, a lower matrix in communication with a fracture at a matrix-fracture interface; providing an injection fluid comprising a wettability altering agent; injecting the injection fluid into the fractured reservoir; contacting the upper matrix and the lower matrix at the matrix-fracture interface with the wettability altering agent; and altering the wettability of the matrix-fracture interface to a more hydrophilic state to increase the gravity drainage rate, wherein oil produced from the upper matrix flows within the fracture instead of reimbibing into the lower matrix underneath. The injection fluid may be any injection fluid with a wettability altering agent or a foam of this injection fluid and a gas. The injection fluid may be injected into the fractured reservoir at a reservoir top, a reservoir bottom or both and the injection may be before or during the gravity drainage process into the fracture. The wettability altering agent include cationic surfactants, anionic surfactants, nonionic surfactants, aqueous ions, chelating agents, sequestration agents, acids, alkali, solvents, silanes, fatty acid complexes, and aromatic/asphaltic oils. For example, the wettability altering agent is sodium polyacrylate (NaPA), ENORDET® A092 or both.

The present invention provides a process for increasing oil recovery from a water-wet fractured oil-bearing formation employing gravity drainage techniques by identifying a fractured reservoir comprising an upper matrix, a lower matrix in communication with a fracture at a matrix-fracture interface; providing an injection fluid comprising a wettability altering agent; injecting the injection fluid into the fractured reservoir; contacting the upper matrix and the lower matrix at the matrix-fracture interface with the wettability altering agent; and altering the wettability of the matrix-fracture interface to a more hydrophilic state, wherein oil produced from the upper matrix flows within the fracture instead of reimbibing into the lower matrix underneath to increase oil recovery. The injection fluid may be any injection fluid with a wettability altering agent or a foam of this injection fluid and a gas. The injection fluid may be injected into the fractured reservoir at a reservoir top, a reservoir bottom or both and the injection may be before or during the gravity drainage process into the fracture. The wettability altering agent include cationic surfactants, anionic surfactants, nonionic surfactants, aqueous ions, chelating agents, sequestration agents, acids, alkali, solvents, silanes, fatty acid complexes, and aromatic/asphaltic oils. For example, the wettability altering agent is sodium polyacrylate (NaPA), ENORDET® A092 or both.

The present invention provides a process for recovering oil from a water-wet fractured oil-bearing formation having an injection well and production well in fluid communication with a substantial portion of the formation by identifying a fractured reservoir comprising an upper matrix, a lower matrix in communication with a fracture at a matrix-fracture interface; providing an injection well and a production well in the fractured reservoir; providing an injection fluid comprising a wettability altering agent; injecting the injection fluid into the injection well, contacting the upper matrix and the lower matrix at the matrix-fracture interface with the wettability altering agent; and altering the wettability of the matrix-fracture interface to a more hydrophilic state, wherein oil produced from the upper matrix flows within the fracture instead of reimbibing into the lower matrix underneath to increase oil recovery. The injection fluid may be any injection fluid with a wettability altering agent or a foam of this injection fluid and a gas. The injection fluid may be injected into the fractured reservoir at a reservoir top, a reservoir bottom or both and the injection may be before or during the gravity drainage process into the fracture. The wettability altering agent include cationic surfactants, anionic surfactants, nonionic surfactants, aqueous ions, chelating agents, sequestration agents, acids, alkali, solvents, silanes, fatty acid complexes, and aromatic/asphaltic oils. For example, the wettability altering agent is sodium polyacrylate (NaPA), ENORDET® A092 or both.

### BRIEF DESCRIPTION OF THE DRAWINGS

For a more complete understanding of the features and advantages of the present invention, reference is now made to the detailed description of the invention along with the accompanying figures and in which:

FIG. 1 is an image of the drainage of oil by gas in a layered fractured reservoir and reimbibition of oil into underneath blocks.

FIG. 2 is an image of the drainage of oil by gas in a layered fractured reservoir without reimbibition of oil into underneath blocks.

FIG. 3 is a graph of the imbibition oil recovery profiles for the different combinations of sodium polyacrylate (NaPA) and ENORDET® A092, at 100° C. and neutral pH.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Many oil-wet/mixed-wet fractured reservoirs employ gravity drainage to recover oil. The gravity drainage is caused by the density difference between the injected fluid (e.g., gas, steam, water, surfactant water) and oil. The gravity drainage is often controlled by the thickness of the pay zone, even though vertical barriers are present in the matrix and the matrix is broken up into several layers. The oil drains out of the top layers into the vertical fractures, but reimbibes into the underneath layer because the matrix is oil-wet/mixed-wet. Thus, the drainage rate is inversely proportional to the total height of the whole pay zone. The goal of this invention is to prevent the reimbibition of oil into underneath layers to increase the oil drainage rate. For example, in a gas-oil drainage process, a small amount of wettability altering agent will be injected periodically into the fractures in terms of an aqueous solution or foam before or during gas injection from the top. The wettability-altering agent will imbibe into the near-fracture region of the matrix and change the wettability to a more water wetting (hydrophilic) state only in that region. Thus, the oil produced from higher layers will flow in the fractures instead of reimbibing into the underneath matrix layers. The treatment of wettability agent can be repeated periodically if the wettability agent degrades over the long time. The wettability agent can be any water-wetting chemicals including surfactants (cationic, nonionic or anionic), aqueous ions, chelating agents, sequestration agents, acids, alkali, and solvents.

The gravity drainage is caused by the density difference between the injected fluid and oil and is controlled by vertical oil permeability in the matrix, viscosity of oil, and capillary forces. Hagoort (1980) describes an analytical solution for immiscible gas drainage in a homogeneous matrix block. Approximating the flow to be one-dimensional, the drainage rate is constant in the initial period followed by a decline after gas breakthrough. The initial drainage rate, q, is given by

q=Ak_{z}(kᵣₒ/μₒ)Δρg(1-H_{c}/H),

wherein A is the cross-sectional area, k_{z} is the vertical permeability, kᵣₒ is the oil permeability at the initial condition, μₒ is the oil viscosity, Δρ is the density difference, g is the acceleration due to gravity, H is the height of the matrix block, and H_{c} is the capillary hold-up height. This analysis has been improved including the width of the matrix blocks (Clemens & Wit, 2001). Since for a given matrix block oil volume Vₒᵢ, the area:

A=Vₒᵢ/(HφSₒᵢ),

the oil drainage rate is inversely proportional to the height of the matrix block.

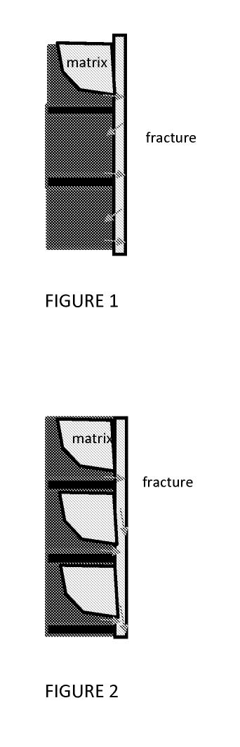

FIG. 1 is an image of the drainage of oil by gas in a layered fractured reservoir and reimbibition of oil into underneath blocks. In layered reservoirs, oil drains out of the top layers into the vertical fractures, but reimbibes into the underneath layer because the matrix is oil-wet/mixed-wet (Firoozabadi et al., 1991). Thus, the drainage rate is controlled by the total height of the whole pay zone. In the past, several methods have been developed to increase the oil drainage rate (Boerrigter et al., 2007). Gravity drainage with steam increases the reservoir temperature and reduces the oil viscosity. This process is limited by the thermal diffusion and is energy intensive because the whole reservoir needs to be heated up. Gravity drainage by miscible gas injection increases oil recovery by reducing interfacial tension between oil and gas. Availability of miscible gas is a potential issue for this process. Surfactant water can be injected into fractures from the bottom. Surfactants can reduce the capillary holdup; this process is also slow because the density difference is smaller between oil and water than between oil and gas (Seethepalli et al., 2004). Pressurization followed by surfactant water injection has been proposed which accelerates surfactant penetration into the matrix (Adibhatla & Mohanty, 2011). The present invention provides a method and compositions to increase the oil drainage rate by preventing the reimbibition of oil into underneath layers.

The oil drained out of the top block into the fracture in FIG. 1 reimbibes into the underneath matrix block because the matrix is oil-wet or mixed-wet. If the matrix at the matrix-fracture interface can be made more water-wet, the oil would flow down the fracture instead of imbibing back into the matrix. FIG. 2 sketches such a scenario.

FIG. 2 is an image of the drainage of oil by gas in a layered fractured reservoir without reimbibition of oil into underneath blocks. In this case, the oil drainage rate would be higher because each layer will contribute oil independently. The oil rate is now inversely proportional to thickness of each layer instead of thickness of the whole pay zone. If the zone consists of 10 equal layers, then the oil drainage rate would increase 10 times.

A small amount of wettability altering agent can be injected periodically into the fractures in terms of an aqueous solution or foam before or during gas injection from the top. Similar technique can also be applied for water injection or aquifer invasion from the bottom. The wettability-altering agent will imbibe into the near-fracture region of the matrix and change the wettability to a more water-wetting (hydrophilic) state only in that region. Thus, the oil produced from higher layers will flow in the fractures instead of reimbibing into the underneath matrix layers. The treatment of wettability agent can be repeated periodically if the wettability agent degrades over the long time. The wettability agent can be any water-wetting chemicals including surfactants (cationic, nonionic or anionic), aqueous ions, chelating agents, sequestration agents, acids, alkali, and solvents.

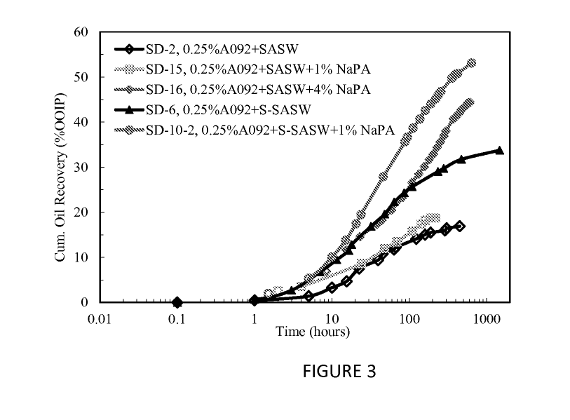

FIG. 3 shows the imbibition oil recovery profiles for the different combinations of sodium polyacrylate (NaPA) and ENORDET® A092, at 100° C. and neutral pH. FIG. 3 shows one example of oil recovery by spontaneous imbibition of several aqueous solutions in laboratory cores (Chen & Mohanty, 2014). These core samples were saturated with oil and connate brine Immersing such cores in formation brine does not lead to any spontaneous imbibition of brine. A092 is a surfactant and reduces interfacial tension between water and oil. The addition of NaPA and use of softened sea water makes the rock more water-wet. Increase in wettability alteration increases spontaneous imbibition of water and oil drainage rate. Wettability altering agents depend on the rock, reservoir oil, and brine composition. Once the target reservoir is identified, laboratory tests can be done to identify the wettability altering materials.

Wettability alteration (without gravity drainage) is a slow process. Stoll et al. (2007) claim that it is controlled by diffusion of wettability modifiers, with an effective diffusion coefficient of about 10⁻¹¹ m²/s. Thus, altering the wettability of the interfacial region (near the fracture-matrix interface) can be fairly quick (hours), but that of a whole matrix block of size 10 m would take a long time (decades). The present process overcomes this time-scale difficulty by targeting the wettability alteration of the fracture-matrix interfacial region.

The present invention provides the injection of a small amount of wettability altering material before or during the gravity drainage process into the fracture. The amount of material should be sufficient to change the wettability of the matrix-fracture interfacial region to a depth of a few cm. If in a gas-oil drainage process, brine with the wettability altering agent is injected into the fracture, the brine will flow down the fracture while imbibing into the fracture. The flow in the fracture may be unstable depending on the fracture width, injection rate. For getting 100% coverage in the matrix-fracture interface, the flow of brine has to be stable. The stability could be achieved by injecting a foam of brine (with wettability altering agents) and gas. The normal gravity drainage process can be continued after the injection of the wettability alteration material. The wettability alteration material will make the fracture- matrix surface hydrophilic and prevent re-imbibition of oil produced from upper layers.

The wettability alteration material deposited in the matrix may degrade over the long life time of the reservoir. This will be detected if the oil drainage rate decreases to the before treatment level. In such cases, the wettability alteration treatment can be repeated periodically.

This wettability alteration treatment can be applied to all gravity drainage processes (e.g., gas-oil gravity drainage, steam-oil gravity drainage, water-oil gravity drainage, surfactant-water gravity drainage, etc.).

The present invention uses sodium polyacrylate (NaPA) as an example; other reagents include acrylate/alkyl-acrylate cross-polymer, e.g., acrylate/C10-30 alkyl-acrylate cross-polymer, poly C10-30 alkyl-acrylate, Potassium acrylate/C10-30 alkyl-acrylate cross-polymer, Sodium acrylate/C10-30 alkyl acrylate cross-polymer; polyacrylate, e.g., potassium aluminum polyacrylate, potassium polyacrylate, sodium polyacrylate, sodium polyacrylate starch, ammonium polyacrylate and glyceryl polyacrylate; sodium polyacrylate, polyacrylamide, sodium carboxymethylcellulose, and polyacrylonitrile.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A process for enhancing oil recovery from a water-wet fractured oil-bearing formation comprising the steps of:
identifying a fractured reservoir comprising a multi-layered matrix in communication with a fracture at a matrix-fracture interface;
providing an injection fluid comprising a wettability altering agent;
injecting the injection fluid into the fractured reservoir;
contacting the matrix at the matrix-fracture interface with the wettability altering agent; and
altering the wettability of the matrix-fracture interface to a more hydrophilic state, wherein oil produced flows within the fracture instead of reimbibing into the matrix underneath.

2. The method of claim 1, wherein the injection fluid is an aqueous solution of a wettability altering agent or agents.

3. The method of claim 1, wherein the injection fluid is a foam containing wettability altering agents.

4. The method of claim 1, wherein the injection fluid is injected into the fractured reservoir at a reservoir top, a reservoir bottom or both.

5. The method of claim 1, wherein the wettability altering agent comprises cationic surfactants, anionic surfactants, nonionic surfactants, aqueous ions, chelating agents, sequestration agents, acids, alkali, solvents, silanes, fatty acid complexes, and aromatic/asphaltic oils.

6. The method of claim 1, wherein the wettability altering agent is sodium polyacrylate (NaPA). ENORDET® A092 or both.

7. The method of claim 1, wherein the injection is before or during the gravity drainage process into the fracture.

8. A method for treating a subterranean formation with a wettability altering agent comprising the steps of:
forming a fluid comprising a wettability altering agent;
introducing the fluid into a subterranean formation with exposed surfaces; and
modifying the wettability of the particulate or surfaces or both, wherein the wettability modification results in oil flowing into a fracture instead of reimbibing.

9. The method of claim 8, wherein the fluid is injected into the subterranean formation from the top, the bottom or both.

10. The method of claim 8, wherein the wettability altering agent comprises cationic surfactants, anionic surfactants, nonionic surfactants, aqueous ions, chelating agents, sequestration agents, acids, alkali, solvents, silanes, fatty acid complexes, and aromatic/asphaltic oils.

11. The method of claim 8, wherein the wettability altering agent is sodium polyacrylate (NaPA). ENORDET® A092 or both.

12. The method of claim 8, wherein the injection is before or during the gravity drainage process into the fracture.

13. A process for increasing a gravity drainage rate for oil recovery in oil-wet/mixed-wet fractured oil-bearing formation comprising the steps of:
identifying a fractured reservoir comprising a multi-layered matrix in communication with a fracture at a matrix-fracture interface;
providing an injection fluid comprising a wettability altering agent;
injecting the injection fluid into the fractured reservoir;
contacting the matrix at the matrix-fracture interface with the wettability altering agent; and
altering the wettability of the matrix-fracture interface to a more hydrophilic state to increase the gravity drainage rate, wherein oil produced from the matrix flows within the fracture instead of reimbibing into the matrix underneath.

14. The method of claim 13, wherein the injection fluid is a brine.

15. The method of claim 13, wherein the injection fluid is a foam.

16. The method of claim 13, wherein the injection fluid is injected into the fractured reservoir at a reservoir top, a reservoir bottom or both.

17. The method of claim 13, wherein the wettability altering agent comprises cationic surfactants, anionic surfactants, nonionic surfactants, aqueous ions, chelating agents, sequestration agents, acids, alkali, solvents, silanes, fatty acid complexes, and aromatic/asphaltic oils.

18. The method of claim 13, wherein the wettability altering agent is sodium polyacrylate (NaPA). ENORDET® A092 or both.

19. The method of claim 13, wherein the injection is before or during the gravity drainage process into the fracture.

20. A process for increasing oil recovery from a water-wet fractured oil-bearing formation employing gravity drainage techniques comprising the steps of:
identifying a fractured reservoir comprising a multi-layered matrix in communication with a fracture at a matrix-fracture interface;
providing an injection fluid comprising a wettability altering agent;
injecting the injection fluid into the fractured reservoir;
contacting the matrix at the matrix-fracture interface with the wettability altering agent; and
altering the wettability of the matrix-fracture interface to a more hydrophilic state, wherein oil produced flows within the fracture instead of reimbibing into the matrix underneath to increase oil recovery.

21. A process for recovering oil from a water-wet fractured oil-bearing formation having an injection well and production well in fluid communication with a substantial portion of the formation, comprising the steps of:
identifying a fractured reservoir comprising a multi-layered matrix in communication with a fracture at a matrix-fracture interface;
providing an injection well and a production well in the fractured reservoir;
providing an injection fluid comprising a wettability altering agent;
injecting the injection fluid into the injection well;
contacting the matrix at the matrix-fracture interface with the wettability altering agent;
altering the wettability of the matrix-fracture interface to a more hydrophilic state, wherein oil produced flows within the fracture instead of reimbibing into the matrix underneath; and
increasing the oil recovery from the production well.
